(19) United States
(12) Patent Application Publication
(10) Pub. No.: US 2026/0351058 A1
(43) Pub. Date: Nov. 5, 2026

(54) A METHOD FOR CONTROLLING SEQUENTIAL ACCESS TO MULTIPLE ELECTRONIC LOCKS

(71) Applicant: IGLOOCOMPANY PTE. LTD., Singapore (SG)

(72) Inventors: Khee Kien HO, Singapore (SG); Thien Sean LIM, Singapore (SG); Anthony Wen Jie CHOW, Singapore (SG)

(73) Assignee: IGLOOCOMPANY PTE. LTD., Singapore (SG)

(21) Appl. No.: 19/486,392

(22) PCT Filed: May 24, 2024
(86) PCT No.: PCT/SG2024/050352

§ 371 Date: Nov. 21, 2025

(30) Foreign Application Priority Data
May 26, 2023 (SG) 10202301503Y

(51) Int. Cl. G07C 9/00

(52) U.S. Cl. CPC G07C 9/00182; G07C 9/00563

(57) ABSTRACT

A method for controlling sequential access to a premise is disclosed, the premise comprising a plurality of electronic locks, each associated with a physical barrier and including a lock controller, a lock processor, and a memory storing executable instructions. The method comprises: assigning, by a lock control device, a sequential unlock mode to two or more electronic locks to define a first group; configuring, by the lock control device, an unlock trigger on a lead electronic lock for sequentially unlocking the remaining electronic locks in the first group; generating an unlock event by the lead electronic lock; determining if the unlock event matches the unlock trigger; and transmitting, by the lock control device, an unlock command to the remaining electronic locks within the first group if the unlock event matches the unlock trigger to activate the sequential unlock mode, thereby unlocking the remaining electronic locks in a sequential manner.

### TECHNICAL FIELD

The present disclosure generally relates to electronic locks. More particularly, the present disclosure relates to multiple electronic locks configured for sequential access to a premise.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Traditional approaches to unlocking multiple locks often involve mechanical means, requiring individuals to physically engage with each lock sequentially. Alternatively, wireless interconnectivity between locks has been explored, enabling simultaneous unlocking through a centralized control mechanism. Additionally, the utilization of pre-programmed key fobs has been proposed, offering users the convenience of storing multiple keys within a single device. However, these existing solutions predominantly concentrate on addressing the ingress dilemma, neglecting the intricacies associated with both ingress and egress procedures on the main door lock.

A common scenario where the limitations of current solutions become apparent is in the context of residential properties, particularly in urban settings such as Singapore. Here, it is customary to encounter a configuration comprising a metal gate preceding a wooden door, necessitating the manipulation of multiple locks to gain entry. This arrangement, while serving security purposes, introduces a layer of complexity and inconvenience for users. The process of sequentially unlocking each lock point not only consumes time but also presents opportunities for errors to occur, leading to frustration and potential security risks.

Additionally, another prior art solution employs a pre-programmed key fob that stores multiple keys. The key fob is used to unlock a single lock at a time, requiring the user to perform sequential unlock actions in reverse order for egress. Although this approach offers some convenience by eliminating the need to carry and manage numerous physical keys, it still necessitates users to remember the correct sequence of unlocking both ingress and egress locks.

Despite the advancements made in addressing the ingress challenge, the issue of sequential unlocking for both ingress and egress remains inadequately resolved within the existing landscape of electronic lock systems. While the ingress problem pertains to facilitating entry into a premise, the egress challenge involves the smooth exit from the same premise. Existing solutions fail to provide a holistic approach that seamlessly caters to both aspects of access control on the main door lock.

In light of these shortcomings, there exists a pressing need for a solution that can simplify and streamline the process of sequential unlocking for both ingress and egress on multi-lock systems while ensuring user convenience and security. Accordingly, the present invention attempts to address or to overcome at least some of the aforementioned problems.

### SUMMARY OF THE INVENTION

In a first aspect of the present invention, there is a method for controlling sequential access to a premise utilizing electronic locks. In this context, we focus on a method that manages controlled entry and exit to a physical space using interconnected electronic locks.

The first step involves assigning a sequential unlock mode to two or more electronic locks among the plurality of available locks. This arrangement may be seen as configuring certain locks within the system to operate in unison for the purpose of granting access to a specific area. One advantage of this is that it allows for efficient and coordinated control over multiple entry points, enhancing security and convenience.

It may be provided that a lock control device assigns the sequential unlock mode to these electronic locks. The term “lock control device” refers to an entity responsible for managing and regulating access through the connected electronic locks within the premise. This arrangement enables centralized control over the sequence of unlocking multiple doors, ensuring orderly entry and exit.

A subsequent step involves configuring, by the lock control device, an unlock trigger on a lead electronic lock for sequentially unlocking the remaining electronic locks in the first group. It next generates an unlock event by the lead electronic lock within the first group, wherein the unlock event is configured for unlocking the lead electronic lock. It then determines if the unlock event matches the unlock trigger for the lead electronic lock. If the unlock event matches the unlock trigger to activate the sequential unlock mode transmitting, by the lock control device, an unlock command to the remaining electronic locks within the first group is sent to thereby unlock the remaining electronic locks within the first group in a sequential manner. One advantage of defining a specific sequence is that it ensures a predetermined flow of access to secure areas within the premise, adding an extra layer of security.

It may be provided that this sequence is defined by a user or an automated system. The term “user” refers to any individual who has been granted permission to interact with the lock control device and set up the desired sequences for unlocking doors. An advantage of allowing users to define these sequences is flexibility, as they can tailor access to their specific needs.

In summary, this method for controlling sequential access to a premise utilizing electronic locks provides several advantages: efficient control over multiple entry points, centralized management through a lock control device, predetermined flow of access to secure areas, flexibility in defining access sequences, precise unlocking order, and real-time monitoring and confirmation of door states.

In a second aspect of the present invention, there is provided an access management system for controlling access to a plurality of electronic locks within a premise. Each electronic lock associated with a physical barrier, comprises a lock control device comprising a communication unit in wireless communication with the plurality of electronic locks, an input unit, a processor in electrical communication with the communication unit and the input unit. The processor is configured to assign a sequential unlock mode to two or more electronic locks among the plurality of electronic locks, configure an unlock trigger on a lead electronic lock configured for sequentially unlocking the remaining electronic locks in the first group, generate an unlock event by the lead electronic lock, wherein the unlock event is configured for unlocking the lead electronic lock, determine if the unlock event matches the unlock trigger for the lead electronic lock, transmit an unlock command to the remaining electronic locks if the unlock event matches the unlock trigger to activate the sequential unlock mode thereby unlocking the remaining electronic locks in a sequential manner.

In a third aspect of the present invention, there is provided an access management system for controlling sequential access to a premise comprising a plurality of electronic locks each associated with a physical barrier, each electronic lock comprising a lock controller, a lock processor, and a memory storing executable instructions within the electronic lock, comprising a lock control device comprising an input unit, a communication unit in wireless communication with the plurality of electronic locks, a processor in electrical communication with the communication unit and the input unit, a server configured to communicate wirelessly with the lock control device and each electronic lock via a communication network.

The server is configured to assign a sequential unlock mode to two or more electronic locks among the plurality of electronic locks, configure an unlock trigger on a lead electronic lock configured for sequentially unlocking the remaining electronic locks in the first group, receive an unlock event by the lead electronic lock, wherein the unlock event is configured for unlocking the lead electronic lock, determine if the unlock event matches the unlock trigger on the lead electronic lock for sequentially unlocking the remaining electronic locks, transmit an unlock command to the remaining electronic locks in the first group if the unlock event matches the unlock trigger to activate the sequential unlock mode thereby unlocking the remaining electronic locks in a sequential manner.

In a fourth aspect of the present invention, there is provided an access management system for controlling sequential access to a premise comprising a plurality of electronic locks each associated with a physical barrier, each electronic lock comprising a lock controller, a lock processor, and a memory storing executable instructions within the electronic lock, comprising a lock control device comprising an input unit, a communication unit in wireless communication with the plurality of electronic locks, a processor in electrical communication with the communication unit and the input unit, a server configured to communicate wirelessly with the lock control device and each electronic lock via a communication network. The lock control device is configured to assign a sequential unlock mode to two or more electronic locks among the plurality of electronic locks, configure an unlock trigger on a lead electronic lock configured for sequentially unlocking the remaining two or more electronic locks, receive an unlock event by the lead electronic lock, wherein the unlock event is configured for unlocking the lead electronic lock, determine if the unlock event matches the unlock trigger on the lead electronic lock for sequentially unlocking the remaining two or more electronic locks, transmit an unlock command to the remaining electronic locks if the unlock event matches the unlock trigger to activate the sequential unlock mode thereby unlocking the remaining two or more electronic locks in a sequential manner.

In a fifth aspect of the present invention, there is provided an access management system for controlling sequential access to a premise comprising a plurality of electronic locks each associated with a physical barrier. Each electronic lock comprises a lock controller, a lock processor, and a memory storing executable instructions within the electronic lock, comprising a lock control device comprising an input unit, a communication unit in wireless communication with the plurality of electronic locks, a processor in electrical communication with the communication unit and the input unit, a gateway device arranged in wireless communication with the plurality of electronic locks, a server configured to communicate wirelessly with the lock control device and the gateway device via a communication network, wherein the lock control device is configured to assign a sequential unlock mode to two or more electronic locks among the plurality of electronic locks, configure an unlock trigger on a lead electronic lock configured for sequentially unlocking the remaining two or more electronic locks, receive an unlock event by the lead electronic lock, wherein the unlock event is configured for unlocking the lead electronic lock, determine if the unlock event matches the unlock trigger on the lead electronic lock for sequentially unlocking the remaining two or more electronic locks, transmit an unlock command to the remaining electronic locks if the unlock event matches the unlock trigger to activate the sequential unlock mode thereby unlocking the remaining two or more electronic locks in a sequential manner.

In a sixth aspect of the present invention, there is provided a method for controlling sequential access to a first electronic lock and a second electronic lock that are not connected to the network, each electronic lock comprising a lock controller, a processor, and a memory storing executable instructions within the electronic lock. The method comprises establishing a secure wireless connection between the first electronic lock and the second electronic lock to define a group pair; generating an access credential for each electronic lock to unlock itself, transmitting the access credential for each electronic lock to the other electronic lock, configuring an unlock trigger on one electronic lock for unlocking the other electronic lock in the group pair, generating an unlock event by the one electronic lock, wherein the unlock event is configured for unlocking the one electronic lock, determining if the unlock event matches the unlock trigger for unlocking the other electronic lock in the group pair; and transmitting, by the one electronic lock, an unlock command to the other electronic lock within the group pair if the unlock event matches the unlock trigger.

### BRIEF DESCRIPTION OF DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a perspective view of a setup of a first physical barrier in front of a second physical barrier according to various embodiments;

FIG. 2 shows a side view of a setup of a first physical barrier in front of a second physical barrier according to various embodiments;

FIG. 3 shows a flow diagram of a method for controlling sequential access to multiple electronic locks according to various embodiments;

FIG. 4a shows various user interface displays for configuring a sequential unlock mode according to various embodiments;

FIG. 4b shows yet other various user interface displays for configuring a sequential unlock mode according to various embodiments;

FIG. 5 shows a flow diagram of a method for controlling sequential access to multiple electronic locks according to various embodiments;

FIG. 6 shows a flow diagram of a method for configuring sequential access to electronic locks that are not connected a network according to various embodiments;

FIG. 7 shows a high-level overview diagram of a method for controlling sequential access to electronic locks that are not connected a network according to various embodiments;

FIG. 8 shows a flow diagram of a method for controlling sequential access to two electronic locks that are not connected a network according to various embodiments;

FIG. 9 illustrates how a secure session between two electronic locks can be established using SPAKE protocol;

FIG. 10 shows a high-level overview of a lock control device according to various embodiments;

FIG. 11 shows a high-level overview of yet another lock control device according to various embodiments;

FIG. 12 shows a high-level overview of an access management system according to various embodiments of the invention;

FIG. 13 shows a high-level overview of yet another access management system according to various embodiments of the invention; and

FIG. 14 shows a high-level overview of yet another access management system according to various embodiments of the invention.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Accordingly, in one or more example embodiments, the functions described may be implemented in hardware, software, or any combination thereof. If implemented in software, the functions may be stored on or encoded as one or more instructions or code on a computer-readable medium.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In order that the invention may be readily understood and put into practical effect, particular embodiments will now be described by way of examples and not limitations, and with reference to the figures. It will be understood that any property described herein for a specific system may also hold for any system described herein. It will be understood that any property described herein for a specific method may also hold for any method described herein. Furthermore, it will be understood that for any system or method described herein, not necessarily all the components or steps described must be enclosed in the system or method, but only some (but not all) components or steps may be enclosed.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “lock” is broadly intended to include any type of lock, including but not limited to, deadbolts, knob locks, lever handle locks, mortise locks, and slide locks, whether mechanical, electrical, or electro-mechanical locks. The locking points may have various mounting configurations and/or locations, including but not limited to: mortised within the doorframe, mounted externally to the doorframe or support structure, affixed directly to the door, to turnstiles, gantries, or any other types of locks affixed on an entry point.

Accordingly, in one or more example embodiments, the functions described may be implemented in hardware, software, or any combination thereof. If implemented in software, the functions may be stored on or encoded as one or more instructions or code on a computer-readable medium.

To achieve the stated features, advantages and objects, the present invention provides a method for controlling sequential access to a premise by managing electronic locks associated with physical barriers. The method assigns a sequential unlock mode to two or more electronic locks among the electronic locks for ingress and egress to the premise. In this aspect, the present invention provides solutions that utilize computer hardware and software to enable a “multiple way sequential unlock” method, system and devices for unlocking multiple locks based on specific unlock triggers. The “multiple way sequential unlock” system and method described herein differentiate between user intent for egress and ingress, allowing for a sequential unlocking process based on the intended direction of movement. The method of the present invention provides the ability to configure an unlock trigger for two or more electronic locks. It may be provided that a lock control device receives an unlock event from one of the two or more electronic locks when the unlock event matches the unlock trigger configured for the sequential unlock mode. If the unlock event matches the unlock trigger to activate the sequential unlock mode, the lock control device sends an unlock command to the two or more electronic locks thereby unlocking the two or more electronic locks in a sequential manner.

In the present invention, a user can trigger the unlocking of a group of locks in a sequential manner, depending on their intended movement. The present invention takes into account the user's desired direction, whether it is exiting or entering a secured area. By recognizing the user's intent, the present invention enables the unlocking of locks in a specific order to facilitate smooth egress or ingress. In the same way, a user can trigger the locking of a group of locks in a sequential manner, depending on the user's intended movement. By recognizing the user's intent, the present invention enables the locking of electronic locks in a specific order to facilitate smooth egress or ingress of a premise.

One advantage of this arrangement is that it enables seamless and coordinated access to multiple points within a premise, as users no longer need to manually unlock each door or barrier individually or to lock each door or barrier individually. This not only saves time but also enhances the overall user experience by providing a more convenient and streamlined process for entering and exiting the premises. Another advantage of this arrangement is that it offers flexibility in access control, as different unlock triggers and lock triggers can be configured for various situations or users. For example, an unlock trigger for one electronic lock could be configured to unlock upon receiving a specific alphanumeric code from an authorized user, while a lock trigger for another electronic lock might require biometric verification before granting entry. Yet another advantage of this arrangement is that it ensures reliable and efficient access control, as only authorized inputs will result in the corresponding locks being activated to open. This reduces the likelihood of unintended lock activations or false positives, which could potentially compromise security or cause inconvenience for legitimate users. Another advantage of this arrangement is that it enhances security by ensuring that doors or barriers are opened in a controlled sequence, thereby preventing unauthorized access, or doors or barriers are locked in a controlled sequence. For instance, if an intruder manages to bypass one lock, they will still need to overcome the remaining locks in the correct sequence to gain entry into the premise.

It should be noted that while the present invention primarily focuses on the unlocking aspect, those skilled in the art will understand that the present invention can also be applied to the locking process. Thus, the term “multi-way sequential unlock” should be interpreted to encompass the method and system of unlocking and locking multiple locks in a sequential manner based on user intent.

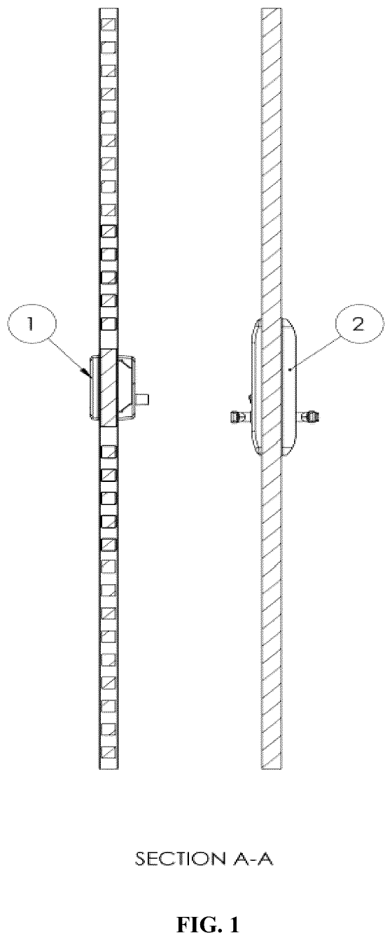

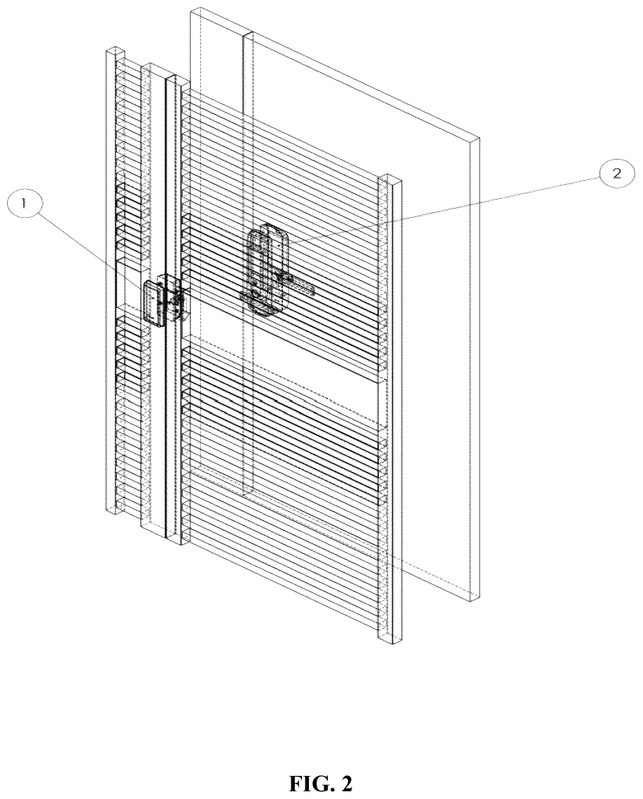

FIG. 1 and FIG. 2 depict an environment where the embodiments described herein can be implemented, showing a perspective view and a side view, respectively. This environment comprises multiple restricted physical spaces that are safeguarded by physical barriers, such as a metal gate (1) and a door (2). In certain scenarios, such as high-rise apartments, condominiums, service apartments, hotels, houses, offices, and similar settings, it is common to encounter a sequential arrangement of physical barriers. This means that before gaining access to an accessible physical space, individuals must pass through a first physical barrier (as a first entry point) and then a second physical barrier (as a second entry point). These physical barriers act as obstacles between the respective restricted physical spaces and the accessible physical space.

A person skilled in the art would understand that while the accessible physical space itself may be restricted, in relation to these specific physical barriers, it is considered accessible. The physical barriers can manifest in various forms, including doors, gates, hatches, cabinet doors, drawers, windows, and so on. Each of the first physical barrier and the second physical barrier is controlled by an electronic lock comprising a lock controller, a memory and a processor responsible for locking and unlocking an electronic lock. The lock controller governs the state of the electronic lock, allowing it to be either locked or unlocked.

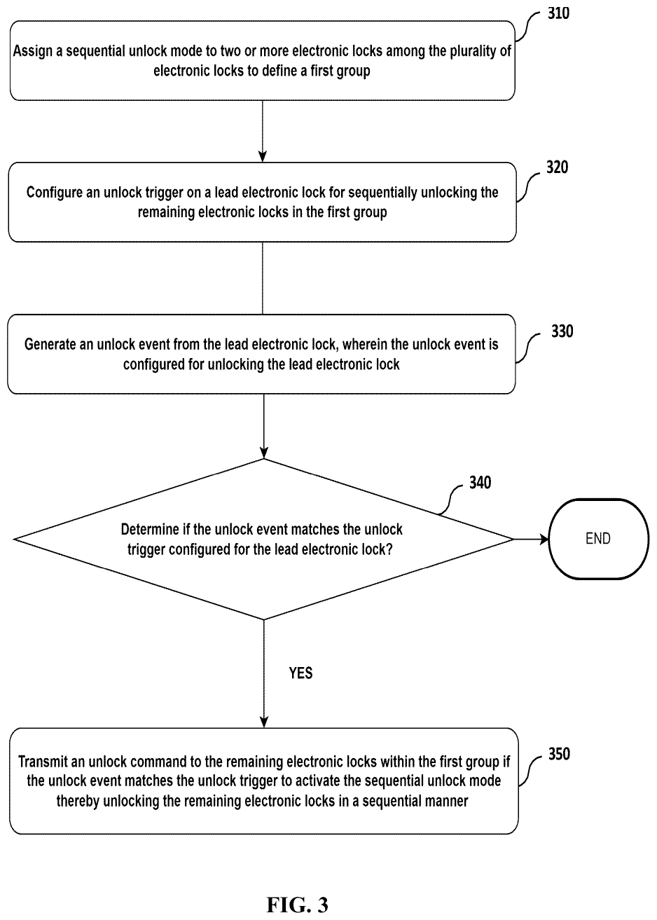

FIG. 3 shows a flow diagram of a method for controlling sequential access to multiple electronic locks according to various embodiments. The method outlines a systematic process for setting up a multi-way sequential unlock for a plurality of locks. In some embodiments, the method described within the flowchart is designed to operate within the context of an access management application. As an example of an embodiment to illustrate the method, we consider a premise such as an apartment setting equipped with multiple electronic locks, each electronic lock associated with a physical barrier. For example, the first electronic lock secures a gate, which serves as the initial physical barrier, while the second electronic lock is responsible for securing the main door, acting as the subsequent physical barrier. To enable the configuration of the multi-way sequential unlocking of these electronic locks, they are interconnected through the access management application installed on a lock control device, details of which will be explained hereinafter. The communication between the lock control device and the electronic locks is facilitated using wireless communication protocols for example, short-range wireless communication protocols or long-range wireless communication protocols. In some embodiments, during the establishment of this connection, cryptographic keys are exchanged to ensure the integrity and security of the communication between the lock control device and the electronic locks.

At step 310, a user will assign a sequential unlock mode to two or more electronic locks among the plurality of electronic locks to define a first group. The user will interact with a lock control device that is in communication with an access management application, details of which will be explained later. Once pairing between the lock control device and the access management application is successfully established, the user gains access to a range of configuration options on a configuration module within the access management application. Within this configuration module, the user can select and designate two or more electronic locks within a plurality of electronic locks to participate in a multi-way sequential unlock. Within the configuration module, the user can specify the electronic locks that will be included in the sequential unlock process by assigning a sequential unlock mode to two or more electronic locks. The term “sequential unlock mode” refers to a specific configuration or a group of electronic locks where the electronic locks are programmed to unlock or lock in a predetermined order. In a non-limiting example, the sequential unlock mode allows a user to configure a predefined number of electronic locks to unlock or lock in multiple ways, for example, for ingress (entrance) or egress (exit) of a premise, or within the ingress or egress of the premise, multiple electronic locks can be assigned in a predetermined order.

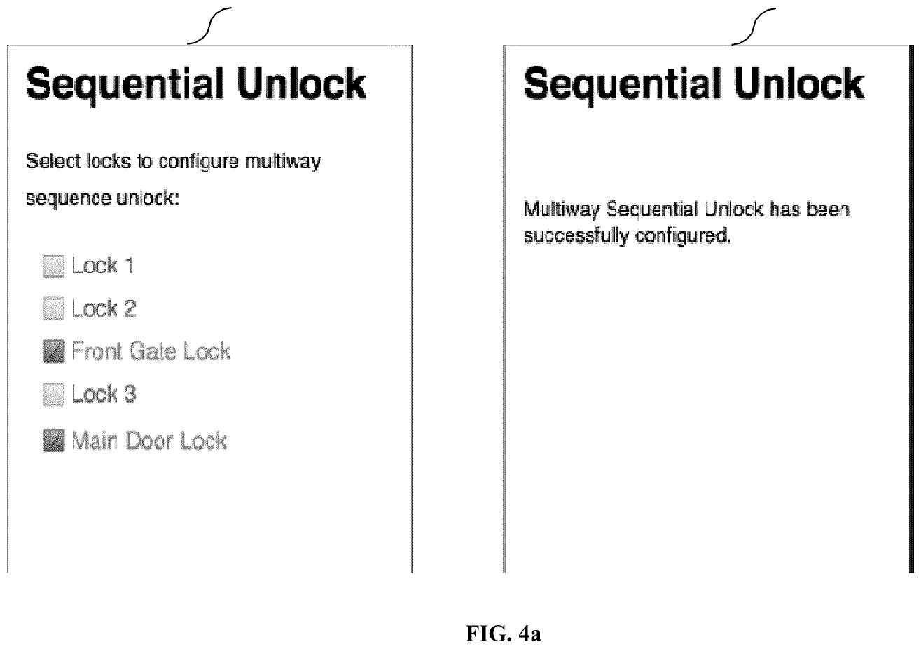

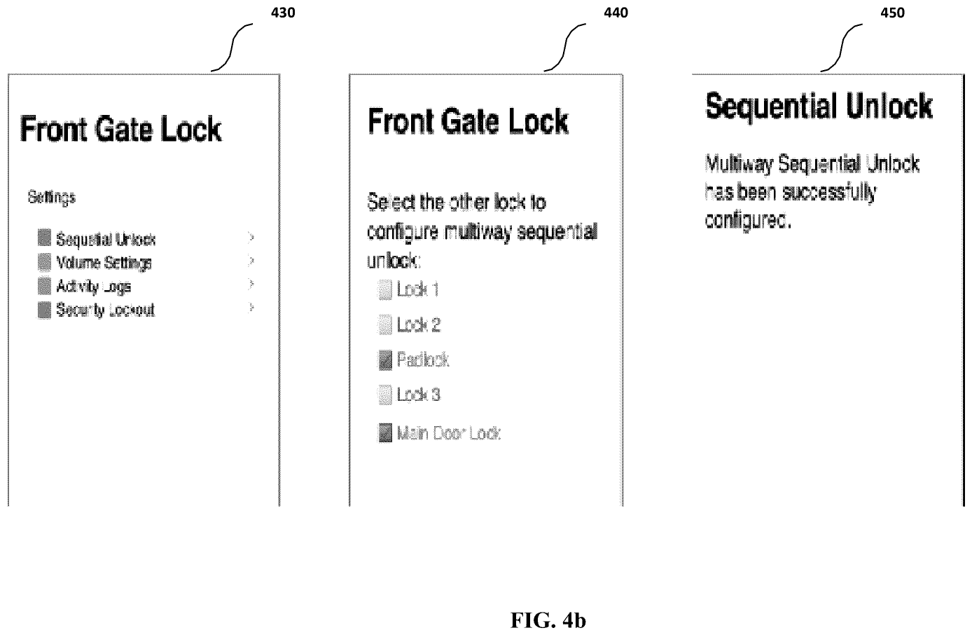

FIG. 4a shows a user interface display to configure a sequential unlock mode on the lock control device according to various embodiments. The user interface display can be accessed on a configuration module on an access management application. As depicted in FIG. 4a, and in one embodiment of a user interface display 410, a user can select two or more electronic locks among the plurality of electronic locks and configure a first group in a streamlined approach or in a simultaneous configuration by allowing the user to select a group of locks and assign a predetermined order to each lock within the first group all at once. In other words, the user can define the sequence in which the selected electronic locks within the first group will be unlocked or locked. This means the user can determine the order in which the electronic locks will be unlocked or locked, enabling a customized and tailored experience. In a non-limiting example, the first group can be assigned by a user for entrance (ingress) to the premise. The user can assign a first electronic lock (for example a metal gate) as lock 1, a second electronic lock (for example, main door) as lock 2, and a third electronic lock (for example, office door) as lock 3. In a further non-limiting example, the first group can be assigned by a user for exiting (egress) the premise. The user can assign a first electronic lock (for example the office door) as lock 1, a second electronic lock (for example, main door) as lock 2, and a third electronic lock (for example, metal gate) as lock 3. In other embodiments, a second group can also be assigned by a user for exiting the premise. For example, the user can assign a first electronic lock (for example the office door) as lock 1, a second electronic lock (for example, main door) as lock 2, and a third electronic lock (for example, metal gate) as lock 3. In a further non-limiting example, a second group can be assigned by a user for exiting (egress) the premise, in addition to the first group for entering (ingress of) the premise. The user can assign the electronic locks in the above designated and sequential manner.

To simplify the process, a predefined rule engine, as discussed earlier, can be utilized. This rule engine automates and simplifies the steps required for configuring multi-way sequential unlock, providing a user-friendly experience. For example, the predefined rule engine allows the user to configure the sequential unlock mode for exiting the premise once the sequential unlock mode for entering the premise is configured. Once the sequential unlock mode has been configured, and in one embodiment of a user interface display 420, the user interface display will confirm to the user that the sequential unlock mode has been successfully configured.

FIG. 4(b) shows an alternative user interface display to configure a sequential unlock mode on the lock control device according to various embodiments. The user interface display can be accessed on a configuration module on an access management application. Alternatively, in another embodiment of a user interface display, a lock settings screen 430, as illustrated in FIG. 4b shows how a user can individually configure each lock within a first group for a sequential unlock mode. The lock settings screen 430 provides a detailed interface that allows the user to select among a plurality of options (for example, sequential unlock mode, volume settings, activity logs, security lookout). When the user selects a sequential unlock mode, the user interface display 440 appears to allow the user to define the unlock sequence for each lock. Once again, a predefined rule engine can be employed to streamline the configuration steps, minimizing the effort and complexity involved in setting up the sequential unlock mode. Once the sequential unlock mode has been configured, and in one embodiment of a user interface display 450, the user interface display will confirm to the user that the sequential unlock mode has been successfully configured.

In various embodiments, the configuration module empowers a user to configure the sequential unlock mode for various lock groups through the access control settings on the access management application. By incorporating features like simultaneous configuration, users can efficiently configure multi-way sequential unlock for the desired locks among a plurality of electronic locks. The inclusion of a predefined rule engine further simplifies the configuration process, ensuring a seamless and user-friendly experience.

At step 320, the user configures an unlock trigger on a lead electronic lock for sequentially unlocking the remaining electronic locks in the first group. The lead electronic lock is the first electronic lock that will activate the sequential unlock of the remaining electronic locks within the first group. An “unlock trigger” is a predefined condition or event that activates the sequential unlock mode for performing the unlocking process of the associated electronic locks when it occurs. The unlock trigger serves as the specific action or authentication method that will prompt or activate the lock to unlock. The configuration module on the access management application offers a range of unlock triggers to choose from, catering to different user preferences and security requirements. In various embodiments, this is provided as options to further customize the sequential unlock mode for each lock within the selected group. Some examples of unlock triggers include PIN unlock, fingerprint unlock, biometric authentication unlock, RFID card unlock, physical key unlock, exit button unlock, and digital key unlock. In various embodiments, each unlock trigger can be associated with a particular user intention, indicating whether it is intended for egress (exiting) or ingress (entering). This allows for a comprehensive access control system that caters to various scenarios and user needs. For instance, the PIN unlock trigger might be used to signal the user's intention to enter a restricted area, while the exit button unlock trigger could be used to indicate the intention to exit a space.

In another embodiment, the predefined rule engine may be used to configure a lead electronic lock that is used as the first lock encountered upon entry, such as a gate lock. In another embodiment, the lead electronic lock can be an electronic lock within the premise that is used as the first lock encountered upon egress or exit of the premise. These electronic locks can be configured to activate the sequential unlock mode specifically upon ingress or exit, ensuring a smooth and streamlined entry or exit process. The unlock triggers for these locks can include options such as PIN unlock, biometric authentication unlock, or RFID card unlock. By configuring these unlock triggers, a user can establish an efficient pathway through the initial lock, facilitating access to the subsequent locks in the sequential unlock sequence.

In another embodiment, and as mentioned above, when the first group of electronic locks is assigned by a user for entrance (ingress) to the premise, the user can assign a first electronic lock or lead electronic lock (for example a metal gate) as lock 1, a second electronic lock (for example, main door) as lock 2, and a third electronic lock (for example, office door) as lock 3. The predefined rule engine can be tailored to allow the user to configure an unlock trigger on the lead electronic lock after the assignment of the first electronic lock is done. For example, an unlock trigger for the first electronic lock can include options such as PIN unlock, biometric authentication unlock, or RFID card unlock for the user to select upon determining the sequence of the electronic lock.

In another embodiment, when the first group is assigned by the user for exiting (egress) the premise, the user can assign a first electronic lock or lead electronic lock (for example the office door) as lock 1, a second electronic lock (for example, main door) as lock 2, and a third electronic lock (for example, metal gate) as lock 3. The predefined rule engine can be tailored to allow the user to configure an unlock trigger for the lead electronic lock within the first group for egress of the premise after the assignment of the first electronic lock is done. For the category of electronic locks that are within the premise, users have the option to define unlock triggers specific to the act of egress. Examples of unlock triggers may include the back exit button or unlocking via the back thumb turn mechanism. The flexibility of the rule engine also allows for customization, where users can configure the electronic locks to respond differently to different unlock triggers. For instance, users may choose to enable sequential unlock mode only when the back exit button of the first electronic lock is pressed, while the back thumb turn action of the first electronic lock does not activate the sequential unlock mode. This level of customization caters to individual preferences and specific use cases. It allows users to have the flexibility to unlock the door lock while leaving the gate lock locked, for example, to ensure enhanced security or separate access control.

At step 330, an unlock event from one of the electronic locks within the first group is generated by the electronic lock. An “unlock event” is a signal generated by the lock controller of an electronic lock configured for unlocking the said electronic lock when validated. In a non-limiting example, the unlock event can be generated upon validation of an authentication input, such as a code or a biometric data for unlocking the electronic lock. In other words, the unlock event is the unlocking of the electronic lock that is separate from the preconfigured unlock trigger for activating the sequential unlock mode. In some embodiments, the lock controller awaits an authentication input from the user. Once an authentication input is received, it is passed to the authentication module for verification and validation. If the authentication input successfully passes the verification process, the electronic lock unlocks and an unlock event is generated by the lock controller. In other embodiments, the unlock event can be generated based on a physical action performed on the electronic lock for unlocking the said electronic lock. For example, certain hardware features of the electronic lock, such as the back exit button or the back thumb turn, can unlock the lock and cause the lock controller to generate an unlock event.

In various embodiments, the lock controller for each electronic lock includes an authentication module to perform validation of an authentication input received by a user. The authentication module plays the role in verifying and validating the authenticity of the authentication input provided against a database or verification algorithm. The authentication inputs may include PIN input, password input, fingerprint input, biometric authentication input, RFID card input or digital keys. Digital keys are based on cryptographic keys that are well known in the art. When an authentication input is received, it undergoes verification and validation processes within the lock controller and authentication module. Once the authentication input is successfully validated, the lock controller initiates the unlocking mechanism and generates an unlock event. The unlock event is stored within a memory of the electronic lock as an activity log. This allows for retrieval, traceability and accountability and enables authorized users to review the activity logs if needed.

At step 340, the lock controller determines if the unlock event generated by the said electronic lock matches the unlock trigger preconfigured for that respective electronic lock within the first group. In various embodiments, the unlock trigger plays a significant role in activating the sequential unlock mode for performing the unlocking of the respective electronic locks within the preselected group. The unlock triggers can be derived from various sources, including authentication unlock events and certain hardware features of the lock itself. The unlock events, resulting from successful authentication inputs, serve as fundamental unlock triggers for activating the sequential unlock mode. The unlock event signifies that the authorized user has been granted access to the electronic lock. Authentication inputs such as PINs, fingerprints, biometric data, RFID cards, physical keys, and digital keys contribute to generating these unlock events. Additionally, unlock triggers may be derived from unlock events based on the electronic lock's specific hardware features. Examples of such triggers include the back exit button located on the lock or the back thumb turn mechanism. Physical key unlocks can also be considered as unlock triggers. In some embodiments, if a lock controller of a first electronic lock determines that the generated unlock event and an unlock trigger that has been preconfigured for the first electronic lock is matched, it will proceed to the next step 350. In other embodiments, if the lock controller of the first electronic lock determines that the generated unlock event and the preconfigured unlock trigger for the first electronic lock does not match, it will not proceed to the next step even though the first electronic lock is unlocked.

At step 350, if the unlock event matches the unlock trigger preconfigured for the said electronic lock, the lock controller will transmit an unlock command to the remaining electronic locks within the first group to activate the sequential unlock mode and to perform the unlocking of the two or more electronic locks in a sequential manner in accordance with the sequential unlock mode. The term “unlock command” refers to a signal sent from the electronic lock to the remaining electronic locks within the first group, instructing the remaining electronic locks to activate the sequential unlock mode and to perform unlock of the said electronic locks. In some embodiments, the unlock event and its corresponding unlock trigger is registered on the lock controller.

When the lock controller receives the unlock event, it will proceed to compare the registered unlock trigger against a preconfigured list of unlock triggers. This configuration of the list of unlock triggers is described above in the configuration of the unlock triggers for each respective electronic lock. This comparison determines whether the current unlock trigger is eligible to activate the sequential unlock process.

If the registered unlock trigger matches one of the designated unlock triggers for activating the sequential unlock mode, the lock controller initiates the sequential unlock mode. It does so by sending the appropriate unlock command to the other locks within the first group that are registered under the sequential unlock mode. This communication is facilitated through the wireless transceiver or communication module of the lock controller.

On the other hand, if the registered unlock trigger does not match any of the designated unlock triggers for sequential unlock, the sequential unlock mode is not activated and will end.

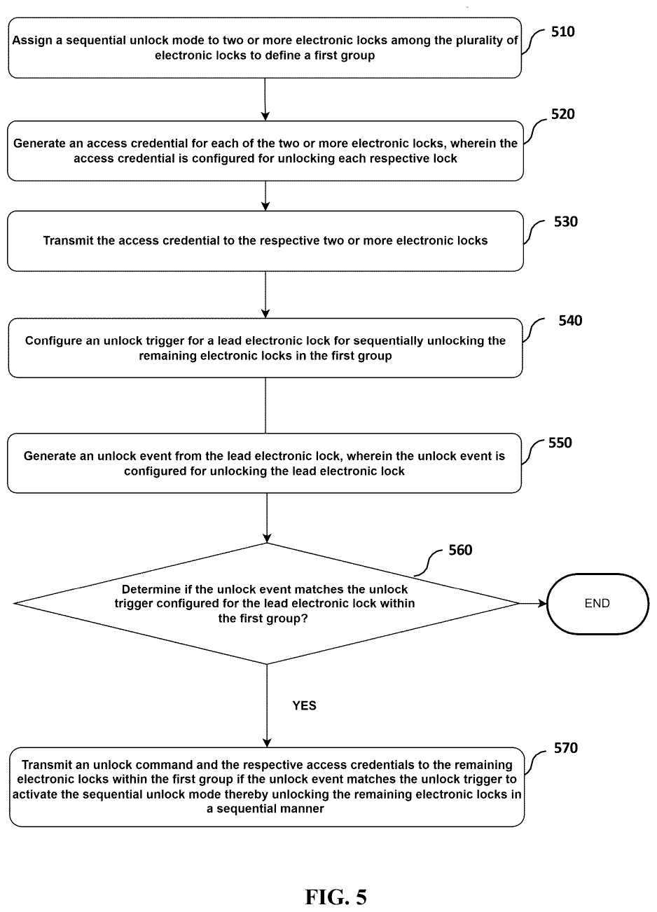

FIG. 5 shows a flow diagram of another method for controlling sequential access to multiple electronic locks according to various embodiments. The method outlines an alternative process for setting up a multi-way sequential unlock for a plurality of locks within a premise. In some embodiments, the method described within the flowchart is designed to operate within the context of an access management application. The premise can be a residential or commercial premise. To enable the configuration of sequential unlocking of these electronic locks, they are interconnected through the access management application installed on a lock control device. The communication between the lock control device and the electronic locks is facilitated using wireless communication protocols for example, short-range wireless communication protocols or long-range wireless communication protocols. In some embodiments, during the establishment of this connection, cryptographic keys are exchanged to ensure the integrity and security of the communication between the lock control device and the electronic locks.

At step 510, and similar to step 310 above, a user will assign a sequential unlock mode to two or more electronic locks among the plurality of electronic locks to define a first group. The user will interact with a lock control device that is in communication with an access management application, details of which will be explained later. Once pairing between the lock control device and the access management application is successfully established, the user gains access to a range of configuration options on a configuration module within the access management application. Within this configuration module, the user can select and designate two or more electronic locks within a plurality of electronic locks to participate in a multi-way sequential unlock. Within the configuration module, the user can specify the electronic locks that will be included in the sequential unlock process by assigning a sequential unlock mode to two or more electronic locks. The term “sequential unlock mode” refers to a specific configuration or a group of electronic locks where the electronic locks are programmed to unlock or lock in a predetermined order. In a non-limiting example, the sequential unlock mode allows a user to configure a predefined number of electronic locks to unlock or lock in multiple ways, for example, for ingress (entrance) or egress (exit) of a premise, or within the ingress or egress of the premise, multiple electronic locks can be assigned in a predetermined order.

At step 520, the access management application or the lock control device generates an access credential for each lock within the first group. Each access credential is configured for unlocking a selected lock within the first group. These access credentials serve as unique identifiers or authorization codes that grant permission to unlock the respective corresponding electronic lock within the first group. The generation of access credentials ensures that each electronic lock within the first group can be individually addressed and controlled.

The techniques to generate the access credential are well-known in the art. In some embodiments, the access credentials involve the use of token-based authentication, which involves the generation of unique tokens that serve as authentication credentials. Each token is associated with a specific electronic lock and is authorized to unlock the targeted lock within the first group. In some other embodiments, the token could be derived from cryptographic pairing keys of the selected electronic lock. In another embodiment, the access credentials involve the use of symmetric-key algorithms, where a shared secret key is employed for both encrypting and decrypting the credentials, establishing a mutual authentication mechanism between the locks. In another embodiment, the access credentials may involve the use of asymmetric key encryption, a technique which employs a pair of mathematically related keys: a public key and a private key. The access credentials are encrypted using the target electronic lock's public key, and the target electronic lock utilizes its private key to decrypt and authenticate the access credentials. In some embodiments, the access credential is generated from an access management application on the lock control device.

At step 530, the access management application or the lock control device transmits the access credential to each respective electronic lock in the group for storage in its respective lock controller and memory. This communication process typically takes place through a secure means, utilizing established protocols and technologies via short-range or long-range wireless communication protocols. Various embodiments of how the lock control device communicates with the electronic locks are described herein. The process iterates through each electronic lock within the first group repeating the aforementioned steps 520 and 530 for each lock individually.

Step 540 is similar to step 320 above and can be referred to above for more details. Step 550 is similar to step 330 above and can be referred to above for more details. Step 560 is similar to step 320 above and can be referred to above for more details. Step 570 is similar to step 320 above and can be referred to above for more details.

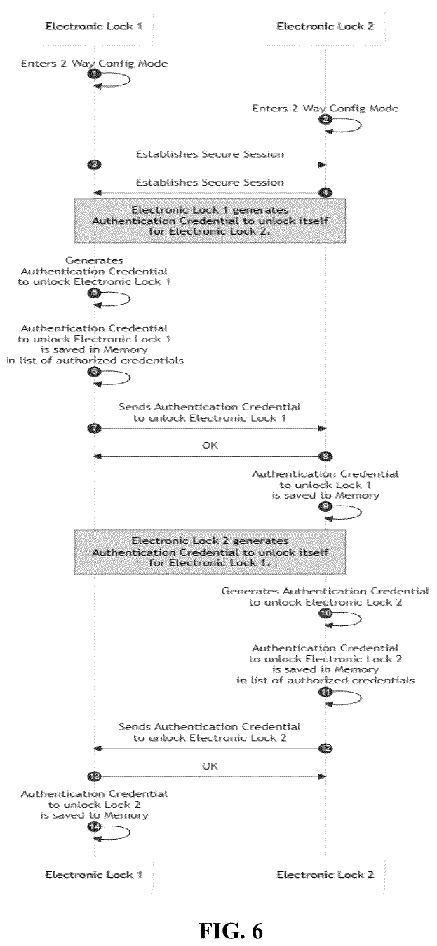

FIG. 6 depicts a flow diagram for a method for controlling sequential access to a electronic locks that are not connected to the network. In the previous embodiments, the electronic locks are interconnected to one another via a lock control device and an access management application via wireless communication protocols. In the event where a lock control device and/or an access management application is not available, it is still possible to configure a multi-way sequential unlock for multiple electronic locks within a premise through manual configuration.

The process begins with pairing the respective electronic locks to communicate with one another. In a first step, a user will first enter an administration mode of Electronic Lock 1 by inputting an admin code. The admin code can be a preconfigured code determined by a user or a default admin code determined by the lock manufacturer. Once the admin code is entered, the user can select a sequential pairing mode to attempt to establish a connection with another electronic lock. The user will then repeat the step of entering the administration mode of the Electronic Lock 2 by inputting the second electronic lock's admin code. Once the administration mode is entered, the user can select a sequential pairing mode for the Electronic Lock 2, and the Electronic Lock 2 will attempt to discover the other electronic lock (in this case, Electronic Lock 1) in the sequential pairing mode. Once both the Electronic Lock 1 and Electronic Lock 2 are paired, they will establish a secure session and exchange authentication credentials with one another.

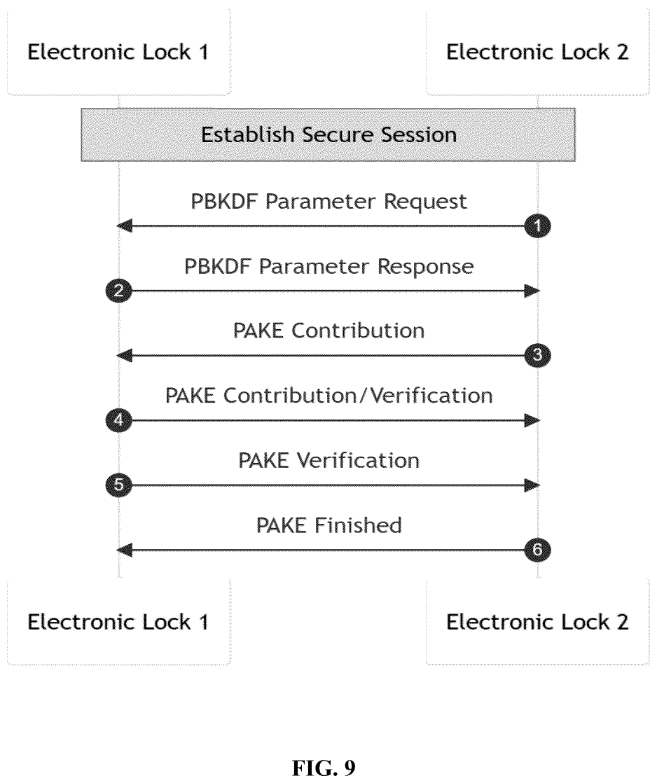

Some methods to get the electronic locks into an administration mode are known in the art. One such embodiment is that the user enters a sequence of keys, for example *123#, to indicate to the electronic lock the intention to enter into the administration mode, followed by keying in the admin PIN. In one embodiment, FIG. 9 illustrates how a secure session between two electronic locks can be established using SPAKE protocol. Once both electronic locks enter the administration mode, the electronic locks can establish a secure session to communicate with each other using short-range or long-range wireless protocols. Techniques to establish a secure session are well known in the art. One such embodiment to establish a secure session is PASE (Password Authenticated Session Exchange) or SPAKE (Secure Password Authenticated Key Exchange) protocols, utilizing the admin PIN as the password. Employing such protocols adds an additional layer of security to the communication channel.

Once the secure session is established, one of the electronic locks, for example Electronic Lock 1, generates an authentication credential required to unlock itself. The authentication credential may be a token-based authentication credential or based on symmetric and asymmetric keys, and they serve as an authentication credential another electronic lock, for example Electronic Lock 2, uses to send an unlock command.

In an embodiment, after generating the authentication credential, Electronic Lock 1 may save the authentication credential in its list of authorized authentication credentials. This list acts as a repository of valid authentication credentials that can be used to unlock the lock, which can be compared against when Electronic 2 sends an unlock command.

In another embodiment, Electronic Lock 1 generates a token based on cryptographic methods. Electronic Lock 1 may use cryptographic methods to validate the authenticity of the authentication credential when Electronic Lock 2 sends an unlock command.

In the next step, Electronic Lock 1 transmits the authentication credential it generated, using its wireless transceiver/communication module, to Electronic Lock 2 wirelessly through the established secure session. This ensures that Electronic Lock 2 receives the necessary authentication credential for the sequential unlock process.

Upon receiving the transmitted authentication credential, Electronic Lock 2 saves the authentication credential in its memory. The authentication credential will be used by Electronic Lock 2 to perform a sequential unlock when the configured unlock triggers are detected.

The configuration process is then repeated on Electronic Lock 2. It generates its own authentication credential to unlock itself, similar to the process performed by Electronic Lock 1. Electronic Lock 2 transmits its generated authentication credential to Electronic Lock 1 through the secure session. The transmission ensures that Electronic Lock 1 receives the necessary authentication credentials for the sequential unlock. This configuration process can be repeated for other pairs of electronic locks that are not connected to a network when there are more than two electronic locks.

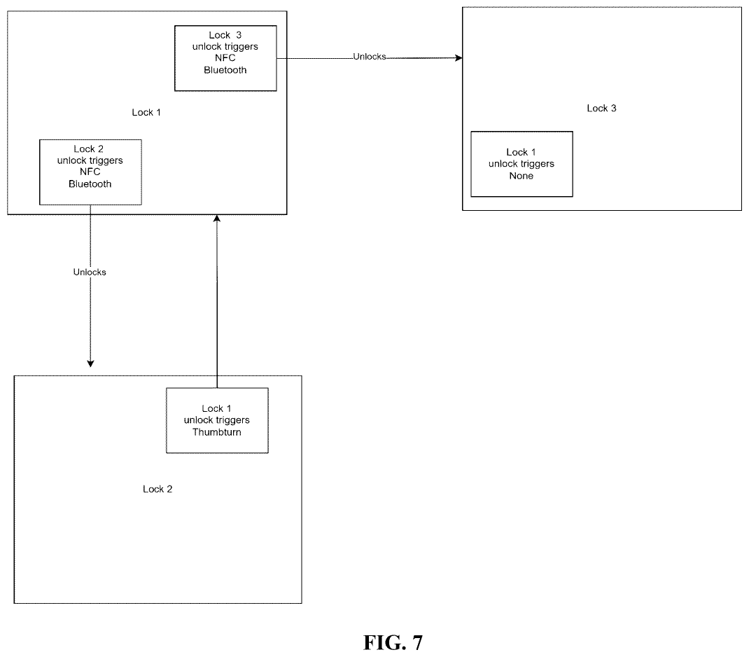

FIG. 7 illustrates a high-level overview diagram of configuring a sequential unlock mode between electronic locks. The user enters a configuration mode on Electronic Lock 1 which is made available when the electronic locks have been paired, secure sessions have been established, and authentication credentials have been exchanged. In this configuration mode, the user has to manually configure an unlock trigger and a paired electronic lock which will unlock the paired electronic lock when the generated unlock event matches with the predetermined unlock trigger. For example, referring to FIG. 7, in the configuration mode, the user can configure a first group pair comprising Electronic Lock 1 and Electronic Lock 2 on Electronic Lock 1. The user configures an unlock trigger for Electronic Lock 2, for example, authentication unlock events and certain hardware features of the lock itself such as a back exit button located on the lock, a back thumb turn mechanism, or even a physical key unlock. This means that within the first group pair, an unlock event that is generated by Electronic Lock 1 will have to match the predetermined unlock trigger for Electronic Lock 2 in order for Electronic Lock 2 to unlock. In this case, the unlock trigger for Electronic Lock 2 is an NFC/Bluetooth or a wireless communication protocol mode of opening. This means that when Electronic Lock 1 is unlocked using a wireless communication protocol mode, this will match with the predetermined unlock trigger for Electronic Lock 2, and it will then proceed to Electronic Lock 2. In the event that Electronic Lock 1 is unlocked using a passcode input on the input device, and as passcode input does not match the unlock trigger for Electronic Lock 2, Electronic Lock 2 will not proceed to unlock.

In the same way, the user can configure a second group pair comprising Electronic Lock 1 and Electronic Lock 3 on Electronic Lock 1. The user configures an unlock trigger for Electronic Lock 3 for the second group pair. This means that within the second group pair, an unlock event that is generated by Electronic Lock 1 will have to match the predetermined unlock trigger for Electronic Lock 3 in order for Electronic Lock 3 to unlock. In this case, the unlock trigger for Electronic Lock 3 is an NFC/Bluetooth or a wireless communication protocol mode of opening. This means that when Electronic Lock 1 is unlocked using a wireless communication protocol mode, this will match with the predetermined unlock trigger for Electronic Lock 2 and Electronic Lock 3, and it will then proceed to unlock Electronic Lock 2 and Electronic Lock 3. In both of the above cases, the embodiments relate to the entrance or ingress of the premise. In the event that Electronic Lock 1 is unlocked using a passcode input on the input device, and as passcode input does not match the unlock trigger for Electronic Lock 3, Electronic Lock 3 will not proceed to unlock.

In another embodiment, and in a case of egress or exit of the premise, the user can configure a third group pair comprising Electronic Lock 1 and Electronic Lock 2 on Electronic Lock 2. The user configures an unlock trigger for Electronic Lock 1 for the third group pair. This means that within the third group pair, an unlock event that is generated by Electronic Lock 2 will have to match the predetermined unlock trigger for Electronic Lock 1 in order for Electronic Lock 1 to unlock. In this case, the unlock trigger for Electronic Lock 1 is a thumbturn. This means that when Electronic Lock 2 is unlocked using the thumbturn, this will match with the predetermined unlock trigger for Electronic Lock 1, and it will then proceed to unlock Electronic Lock 1. In the event that Electronic Lock 2 is unlocked using a passcode input on the input device, and as the passcode input does not match the unlock trigger for Electronic Lock 1, Electronic Lock 1 will not proceed to unlock.

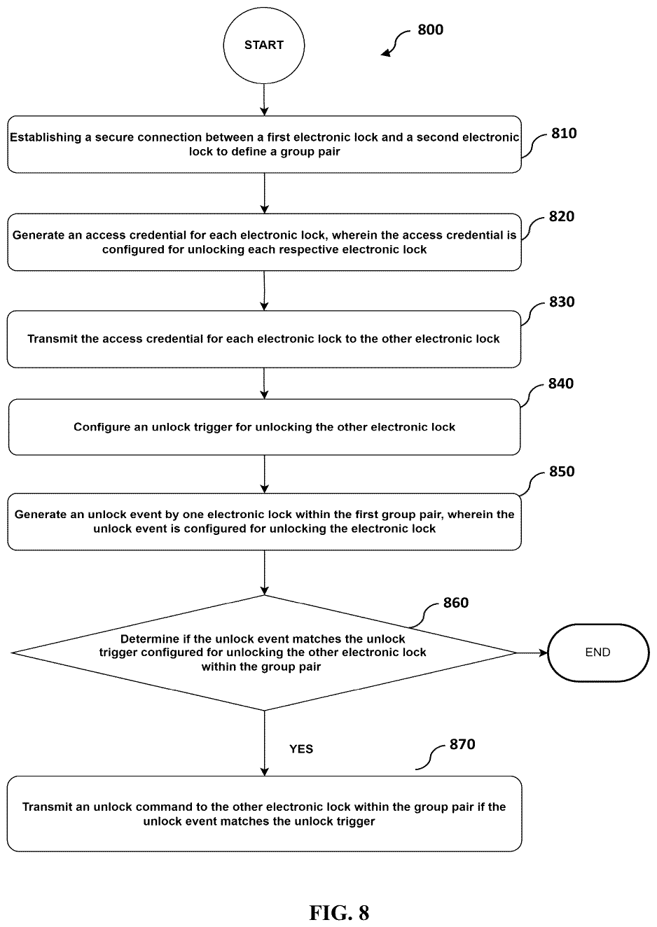

FIG. 8 depicts a flow diagram for a method for controlling sequential access to electronic locks that are not connected to the network. At step 810, the method 800 begins with establishing a secure connection between two electronic locks: a first electronic lock and a second electronic lock, that defines a group pair. Establishing a secure connection between the two electronic comprises a number of steps as elaborated above. In a first step, a user will first enter an administration mode of the first electronic lock by inputting an admin code. The admin code can be a preconfigured code determined by a user or a default admin code determined by the lock manufacturer. Once the admin code is entered, the user can select a sequential pairing mode to attempt to establish a connection with another electronic lock. The user will then repeat the step of entering the administration mode of the second electronic lock by inputting the second electronic lock's admin code. Once the administration mode is entered, the user can select a sequential pairing mode for the second electronic lock, and the second electronic lock will attempt to discover the other electronic lock (in this case, the first electronic lock) in the sequential pairing mode. Once both the first electronic lock and the second electronic lock are paired, they will establish a secure session and exchange authentication credentials with one another.

At step 820, once the secure session is established, one of the electronic locks, for example the first electronic lock, generates an authentication credential required to unlock itself. The authentication credential may be a token-based authentication credential or based on symmetric and asymmetric keys, and they serve as an authentication credential the second electronic lock to send an unlock command. In an embodiment, after generating the authentication credential, the first electronic lock may save the authentication credential in its list of authorized authentication credentials. This list acts as a repository of valid authentication credentials that can be used to unlock the lock, which can be compared against when Electronic 2 sends an unlock command. In another embodiment, the first electronic lock generates a token based on cryptographic methods. The first electronic lock may use cryptographic methods to validate the authenticity of the authentication credential when the second electronic lock sends an unlock command.

At step 830, the first electronic lock transmits the authentication credential it generated, using its wireless transceiver/communication module, to the second electronic lock wirelessly through the established secure session. This ensures that the second electronic lock receives the necessary authentication credential for the sequential unlock process. Upon receiving the transmitted authentication credential, the second electronic lock saves the authentication credential in its memory. The authentication credential will be used by the second electronic lock to perform a sequential unlock when the configured unlock triggers are detected.

The configuration process is then repeated on the second electronic lock. It generates its own authentication credential to unlock itself, similar to the process performed by the first electronic lock. The second electronic lock transmits its generated authentication credential to the first electronic lock through the secure session. The transmission ensures that the first electronic lock receives the necessary authentication credentials for the sequential unlock. This configuration process can be repeated for other group pairs of electronic locks that are not connected to a network when there are more than two electronic locks.

At step 840, the user configures an unlock trigger on the electronic lock for unlocking the other electronic lock in the group pair. For example, if the user configures an unlock trigger on the first electronic lock, the unlock trigger is configured for unlocking the second electronic lock in the group pair. In another example, if the user configures an unlock trigger on the second electronic lock, the unlock trigger is configured for unlocking the first electronic lock in the group pair.

An “unlock trigger” is a predefined condition or event that activates the sequential unlock mode for performing the unlocking process of the associated electronic locks when it occurs. The unlock trigger serves as the specific action or authentication method that will prompt or activate the lock to unlock. The configuration module on the electronic lock offers a range of unlock triggers to choose from, catering to different user preferences and security requirements. In various embodiments, this is provided as options to further customize the sequential unlock mode for each lock within the selected group pair. Some examples of unlock triggers include PIN unlock, fingerprint unlock, biometric authentication unlock, RFID card unlock, physical key unlock, exit button unlock, and digital key unlock. In various embodiments, each unlock trigger can be associated with a particular user intention, indicating whether it is intended for egress (exiting) or ingress (entering). This allows for a comprehensive access control system that caters to various scenarios and user needs. For instance, the PIN unlock trigger might be used to signal the user's intention to enter a restricted area, while the exit button unlock trigger could be used to indicate the intention to exit a space.

At step 850, an unlock event from one of the electronic locks within the group pair is generated by the electronic lock. For example, if a user enters the premise through the first electronic lock, the first electronic lock generates an unlock event. An “unlock event” is a signal generated by the lock controller of an electronic lock configured for unlocking the said electronic lock when validated. In a non-limiting example, the unlock event can be generated upon validation of an authentication input, such as a code or a biometric data for unlocking the electronic lock. In other words, the unlock event is the unlocking of the electronic lock that is separate from the preconfigured unlock trigger for activating the sequential unlock mode. In some embodiments, the lock controller awaits an authentication input from the user. Once an authentication input is received, it is passed to the authentication module for verification and validation. If the authentication input successfully passes the verification process, the electronic lock unlocks and an unlock event is generated by the lock controller. In other embodiments, the unlock event can be generated based on a physical action performed on the electronic lock for unlocking the said electronic lock. For example, certain hardware features of the electronic lock, such as the back exit button or the back thumb turn, can unlock the lock and cause the lock controller to generate an unlock event.

In various embodiments, the lock controller for each electronic lock includes an authentication module to perform validation of an authentication input received by a user. The authentication module plays the role in verifying and validating the authenticity of the authentication input provided against a database or verification algorithm. The authentication inputs may include PIN input, password input, fingerprint input, biometric authentication input, RFID card input or digital keys. Digital keys are based on cryptographic keys that are well known in the art. When an authentication input is received, it undergoes verification and validation processes within the lock controller and authentication module. Once the authentication input is successfully validated, the lock controller initiates the unlocking mechanism and generates an unlock event. The unlock event is stored within a memory of the electronic lock as an activity log. This allows for retrieval, traceability and accountability and enables authorized users to review the activity logs if needed.

At step 860, the lock controller determines if the unlock event generated by the said electronic lock matches the unlock trigger for unlocking the other electronic lock in the group pair. The unlock trigger can be derived from various sources, including authentication unlock events and certain hardware features of the lock itself. The unlock events, resulting from successful authentication inputs, serve as fundamental unlock triggers for activating the sequential unlock mode. The unlock event signifies that the authorized user has been granted access to the electronic lock. Authentication inputs such as PINs, fingerprints, biometric data, RFID cards, physical keys, and digital keys contribute to generating these unlock events. Additionally, unlock triggers may be derived from unlock events based on the electronic lock's specific hardware features. Examples of such triggers include the back exit button located on the lock or the back thumb turn mechanism. Physical key unlocks can also be considered as unlock triggers.

At step 870, if the unlock event matches the unlock trigger for unlocking the other electronic lock, the lock controller will transmit an unlock command and an authentication credential to the other electronic lock within the group pair to activate the sequential unlock mode and to perform the unlocking of the second electronic lock. The term “unlock command” refers to a signal sent from the electronic lock to the remaining electronic lock within the group pair, instructing the electronic lock to activate the sequential unlock mode and to perform unlock of the said electronic lock.

When the lock controller receives the unlock event, it will proceed to compare the registered unlock trigger against a preconfigured list of unlock triggers. This configuration of the list of unlock triggers is described above in the configuration of the unlock triggers for each respective electronic lock. This comparison determines whether the current unlock trigger is eligible to activate the sequential unlock process. Similarly, the transmitted authentication credential is compared against the stored authentication credentials within each respective electronic lock.

If the registered unlock trigger matches one of the designated unlock triggers for activating the sequential unlock mode, and the authentication credential matches the stored authentication credential in the other electronic lock, the other electronic lock initiates the sequential unlock mode. It does so by the first electronic lock sending the appropriate unlock command to the second electronic lock in the group pair. On the other hand, if the registered unlock trigger does not match any of the designated unlock triggers for sequential unlock, the sequential unlock mode is not activated and the second electronic lock will not unlock.

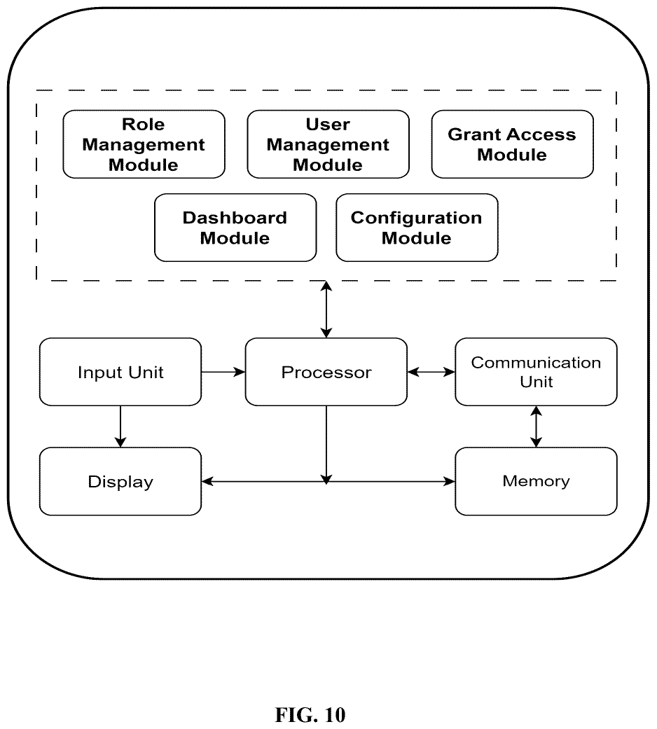

FIG. 10 shows a high-level overview of a lock control device according to various embodiments. The lock control device 500 includes an access management application 510 that is operable on the lock control device 500. The lock control device 500 may include a display 573, a processor 570, an input unit 571, a communication unit 572 and a memory 574. In some embodiments, any other suitable component, including but not limited to a system bus or a controller (not shown), may also be included in the lock control device 500. In some embodiments, a mobile operating system (e.g., iOS™, Android™, Windows Phone™, etc.) and one or more applications (not shown), for example, the access management application, may be loaded into a memory (not shown) from the storage in order to be executed by the processor. The applications may include a browser or any other suitable mobile apps for receiving information relating to the access management application. As appreciated by a person skilled in the art, user interactions with the information stream may be achieved via the I/O devices (not shown) and provided to the processor and/or other components of the system via the network.

In various embodiments, the lock control device 500 may be a computer, laptop, handheld computer, mobile communication device, smartphone, tablet, IoT device, a key fob, a hardware token, a software token, a hardware device installed remotely within the premise, on or any other device. In some embodiments, the lock control device can send and/or receive data over a communication network via short-range wireless communication protocols such as Bluetooth or Bluetooth Low Energy (BLE). In some embodiments, the lock control device is capable of transmitting data via Radio Frequency Identification (RFID) or Ultra High Frequency (UHF).

In various embodiments, the lock control device 500 includes a processor in electrical communication with a display 573 and an input unit 571. The display unit 573 and the input unit 571 can be a single entity although it is shown separately. The input unit 571 is configured to receive input alphanumeric information and various input signals to set the functions and access controls associated with the electronic locks that it is in communication with, and to send the input information and signals to the lock controllers of the electronic locks. In some embodiments, the input unit 571 may include a touch screen, a touch pad, a remote controller device, a keypad that can receive an input gesture. In some embodiments, the input unit 571 may be integrated with the display. In some embodiments, the input unit 571 may function without a display and may include a physical button configured to be depressed to initiate the configuration steps.

In various embodiments, the display 573 is configured to display screen data generated by the operation of the lock control device 500 or the access management application 510, and to display status information according to the user function based on user settings. The display 573 may display various screen data associated with the operations of the access management application for control of the electronic lock and the configuration options associated with the multi-way sequential unlock.

In various embodiments, the communication unit 572 is configured to communicate wirelessly via wireless communication protocols, for example, short-range or long-range wireless communication protocols, with the respective lock groups or individual electronic locks. The communication unit 572 may include a wireless transceiver for transmitting and receiving data for performing functions associated with the lock group or individual electronic lock. In some embodiments, the functions may include pairing, authentication and configuration of the electronic locks.

In various embodiments, the access management application 510 includes a configuration module 560 that facilitates the generation of associated access credentials for the electronic locks within a predetermined group. The configuration module 560 provides various options for customization, including the previously disclosed unlock sequence and unlock triggers. In one embodiment of the configuration module 560, users can configure a group of locks simultaneously, as depicted in FIG. 4a. This streamlined approach allows users to select a first group and apply the desired configuration settings all at once to each respective electronic lock within the first group. To simplify the configuration process, a predefined rule engine, as discussed earlier, can be utilized. This rule engine automates and simplifies the steps required for configuring multi-way sequential unlock, providing a user-friendly experience.

Alternatively, another embodiment of the configuration module offers a lock settings screen, as illustrated in FIG. 4b, where users can individually configure each electronic lock within the first group for a multi-way sequential unlock. The lock settings screen provides a detailed interface that allows users to define the unlock sequence and select specific unlock triggers for each lock. Once again, a predefined rule engine can be employed to streamline the configuration steps, minimizing the effort and complexity involved in setting up multi-way sequential unlock.

Regardless of the chosen configuration method, the configuration module empowers users to customize the access control settings for their lock groups. By incorporating features like simultaneous configuration or the lock settings screen, users can efficiently configure multi-way sequential unlock for their desired locks. The inclusion of a predefined rule engine further simplifies the configuration process, ensuring a seamless and user-friendly experience.

The access management application 510 comprises several modules, such as the user management module 530, role management module 520, grant access module 540, and dashboard module 550. These modules are accessible to users through a mobile application installed on the lock control device, allowing for the configuration of the multi-way sequential unlock for electronic locks. A mobile or a web application can be a mobile or a web application that runs and be executed on, for example, the lock control device.

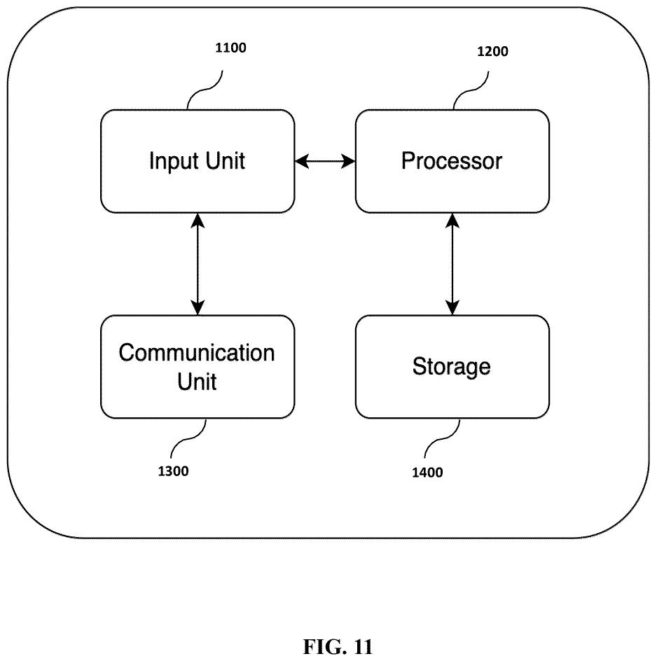

FIG. 11 is an illustration of another embodiment of a lock control device. In this embodiment, the lock control device 1000 may include an input unit 1100, a processor 1200, a communication unit 1300, and a storage 1400. The lock control device 1000 may not have a display or an access management application. A sequential unlock mode can be configured by a mobile device. Interactions with the group or individual electronic locks can be achieved via short range wireless communication protocols via the mobile device. The lock control device 1000 may have an input unit configured to initiate configuration, to generate the authentication credential and transmit the authentication credential to the respective electronic locks. The input gesture may include one or more presses of a physical button on an input. In some embodiments, the input gesture may correspond to the number, amount of time and/or strength of press input, for example, one or two presses, a long press input or short press input based on a time threshold for determining pressing duration and/or strength for transmitting the command for configuration to the electronic locks in the lock group. Each of the input gestures for modifying the configuration of the multi-way sequential unlock can be changed, added or deleted by way of configuration by the user on the input gesture module.

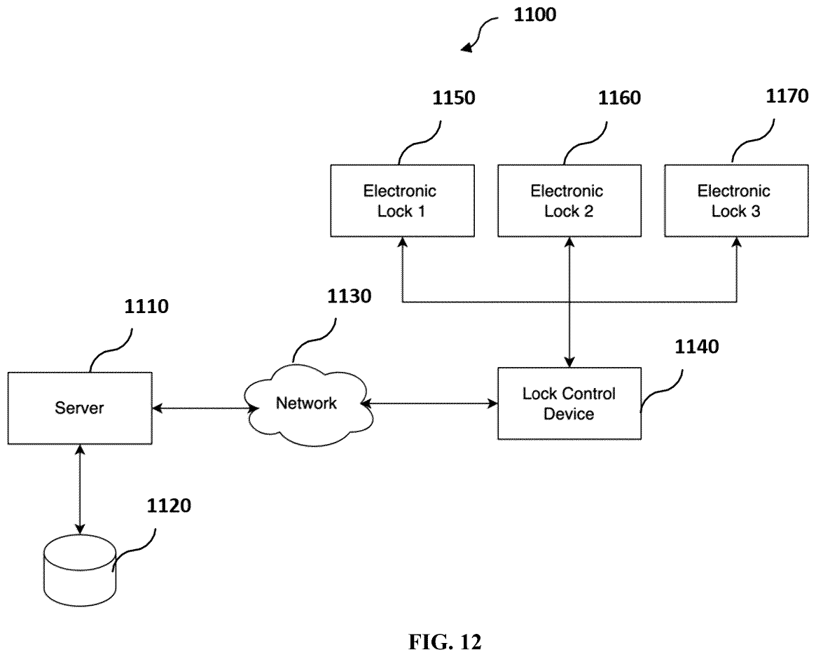

FIG. 12 shows a high-level overview of an access management system according to various embodiments of the invention. The access management system 1100 may be a platform for providing lock management services to one or more users for the management of one or more lock groups of electronic locks for a property. The access management system 1100 may include a server 1110, a network 1130, a lock control device 1140 and a plurality of electronic locks 1150, 1160, 1170. The lock control device 1140 is configured to pair and control the plurality of electronic locks 1150, 1160, 1170 via a network 1130 according to various embodiments. The server 1110 may be configured to process information and/or data relating to the management of electronic locks for a property. In an embodiment, the server 1110 performs the same steps as the lock control device in FIGS. 3 and 5 above. For example, the server 1110 assigns a sequential unlock mode to two or more electronic locks among the plurality of electronic locks to define a group. The server 1110 also configures a lock trigger for each of the two or more electronic locks. The server 1110 also generates an access credential for each of the two or more electronic locks and transmits the access credential to each electronic lock for storage in its respective electronic lock. In other words, the server 1110, through the management operator, determines the predefined unlock sequential mode and predefined unlock triggers for the electronic locks. The server 1110 is arranged in data communication with a storage 1120 which may store relevant data about the lock control device 1140, associated groups of electronic locks and their associated lock IDs, locations, access right owners, access right grantees, etc.. The storage 1120 may be maintained on an application server or on a separate server available for communication over a private network. The server 1110 is in communication with a lock control device 1140 or other lock control devices over the network.

With reference to FIG. 12, the lock control device 1140 may include sensors or transceivers that are capable of using low power wireless transmission standards such as ZWave, Zigbee or Bluetooth low energy, Sigfox, Thread, LoraWAN or Wirepas to communicate with a plurality of electronic locks. Each electronic lock 1150, 1160, 1170 in a lock group, may similarly include sensors or transceivers that are capable of using low power wireless transmission standards such as ZWave, Zigbee or Bluetooth low energy, Sigfox, Thread, LoraWAN or Wirepas to communicate with the lock control device 1140 with the advantage of lower cost, longer battery life and higher connection density. In some embodiments, the lock control device 1140 is capable of transmitting data via Radio Frequency Identification (RFID) or Ultra High Frequency (UHF) to be received by each lock group or individual electronic lock. For example, the lock control device 1140 is capable of sending commands associated with configuration of the multi-way sequential unlock for one or more locks.

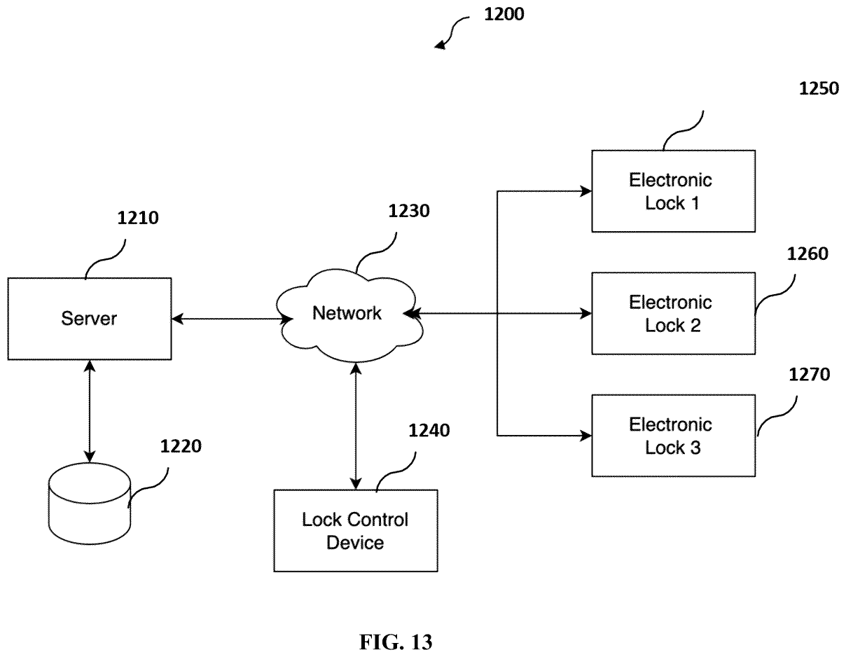

FIG. 13 shows a high-level overview of another embodiment of an access management system according to various embodiments of the invention. In this embodiment, the access management system 1200 includes a lock control device 1240 controlling a plurality of electronic locks 1250, 1260, 1270 through the network 1230. For example, each electronic lock may include a sensor or a wireless transceiver that are capable of connecting to the network via low power wireless transmission standards such as ZWave, Zigbee or Bluetooth low energy, Sigfox, Thread, LoraWAN or Wirepas.. The electronic locks include sensors equipped with such low power wireless technology, and are connected to the network 1230.

In this embodiment, while the steps for configuring locks for multi-way sequential unlock are similar to the steps as described above, the mode of transmission may be different. After the user selects the configuration options on the lock control device on the configuration module, the lock control device 1240 sends the configuration parameters to the electronic locks via the network and/or the server. The server may receive the configuration parameters from the lock control device 1240. The instruction may be a single command, which may then be broken down into the respective configuration commands and corresponding to each electronic lock in the lock group, and wirelessly communicated to each electronic lock in the lock group.

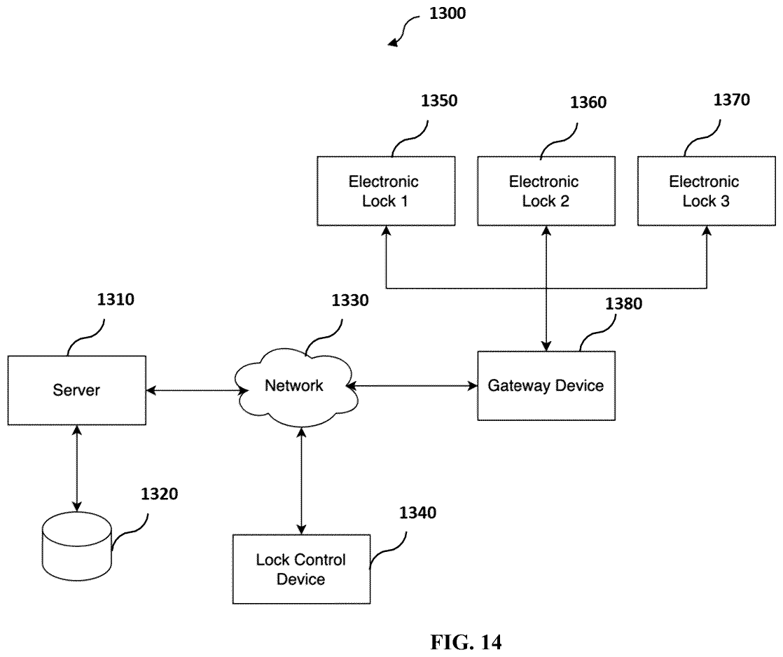

FIG. 14 is an illustration of yet another embodiment of an access management system. In this embodiment, the access management system 1300 includes a plurality of electronic locks 1350, 1360, 1370 arranged in wireless communication with a gateway device 1380 connected to a network 1330. In some embodiments, the electronic locks 1350, 1360, 1370 can be connected to the network 1330 via one or more gateway devices 1380. The gateway device 1380 receives data from the electronic locks 1350, 1360, 1370 and communicates with a lock control device 1340 through the network 1330 to upload individual or aggregated data from the individual lock or the plurality of locks, to send and to receive data from and to the lock control device 1340 or to the server. The gateway device 1380 may also communicate with other gateway devices to provide load balancing of sensor platforms, sensor platform handoff, data aggregation and filtering, and exchange of sensor platform encryption keys, and so forth. Each gateway device 1380 may be participating in a cluster of lock groups, and is typically beneficial that the overall system operates effectively. In some embodiments, the electronic locks include sensors or wireless transceivers that are capable of connecting to the network via wireless transmission standards such as ZWave, Zigbee, Bluetooth low energy, Sigfox, Thread, LoraWAN or Wirepas. The electronic locks include sensors equipped with such short-range or long-range wireless technology, and are connected to the network via the gateway device.

In this embodiment, while the steps for configuring the sequential unlock for the electronic locks are similar to the steps as described above, the mode of transmission of the control signal may be different. After the user selects the configuration options on the lock control device 1340, the lock control device 1340 sends the configuration instruction to the electronic locks 1350, 1360, 1370 via the network 1330 to the gateway device 1380. The instruction may be a single command, which may then be broken down at the gateway device 1380 into the respective configuration commands and corresponding to each electronic lock in the lock group, and wirelessly communicated to each electronic lock in the lock group. Alternatively, separate configuration commands for each lock in the lock group may be communicated to the gateway device from the server. The gateway device will inform the access management application on the lock control device once the configuration operation is concluded.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for controlling sequential access to a premise comprising a plurality of electronic locks each associated with a physical barrier, each electronic lock comprising a lock controller, a lock processor, and a memory storing executable instructions within the electronic lock, the method comprising the steps of:
assigning, by a lock control device, a sequential unlock mode to two or more electronic locks among the plurality of electronic locks to define a first group;
configuring, by a lock control device, an unlock trigger on a lead electronic lock for sequentially unlocking the remaining electronic locks in the first group;
generating an unlock event by the lead electronic lock within the first group, wherein the unlock event is configured for unlocking the lead electronic lock;
determining if the unlock event matches the unlock trigger for the lead electronic lock;
transmitting, by the lock control device, an unlock command to the remaining electronic locks within the first group if the unlock event matches the unlock trigger to activate the sequential unlock mode thereby unlocking the remaining electronic locks within the first group in a sequential manner.

2. The method according to claim 1, wherein the first group is configured for ingress to the premise.

3. The method according to claim 1, wherein the first group is configured for egress to the premise.

4. The method according to claim 1, wherein the sequential unlock mode includes assigning the two or more electronic locks in a predetermined sequential order.

5. The method according to claim 1, wherein the unlock event includes an authentication input that includes one or more of the following: PIN codes, biometric data, RFID card scans, and digital key inputs.

6. The method according to claim 1, wherein the unlock event includes a physical action performed on the electronic lock, including one of the following: a back exit button and a thumb turn.

7. The method according to claim 1, wherein the unlock trigger includes an authentication input that includes one or more of the following: PIN codes, biometric data, RFID card scans, and digital key inputs.

8. The method according to claim 1, wherein the unlock trigger includes a physical action performed on the electronic lock, including one of the following: a back exit button and a thumb turn.

9. The method according to claim 1, wherein the lock control device comprises a display, a processor, an input unit, a communication unit and a memory, wherein the processor is in electrical communication with the display, the input unit, the communication unit and the memory.

10. The method according to claim 9, wherein the communication unit is configured to communicate wirelessly with the plurality of electronic locks via wireless communication protocols.

11. The method according to claim 1, further comprising the steps of:
generating an access credential for each of the two or more electronic locks, wherein the access credential is configured for unlocking each respective two or more electronic locks;
transmitting the access credential to the respective two or more electronic locks.

12. The method according to claim 1, wherein the lock control device includes one of the following: a computer, a laptop, a handheld computer, a mobile device, a smartphone, a tablet, an IoT device, a key fob and a hardware token.

13. An access management system for controlling access to a plurality of electronic locks within a premise, each electronic lock associated with a physical barrier, comprising:
a lock control device comprising a communication unit in wireless communication with the plurality of electronic locks, an input unit, a processor in electrical communication with the communication unit and the input unit, wherein the processor is configured to:
assign a sequential unlock mode to two or more electronic locks among the plurality of electronic locks;
configure an unlock trigger on a lead electronic lock configured for sequentially unlocking the remaining electronic locks in the first group;
generate an unlock event by the lead electronic lock, wherein the unlock event is configured for unlocking the lead electronic lock;
determine if the unlock event matches the unlock trigger for the lead electronic lock;
transmit an unlock command to the remaining electronic locks if the unlock event matches the unlock trigger to activate the sequential unlock mode thereby unlocking the remaining electronic locks in a sequential manner.

14. (canceled)

15. An access management system for controlling sequential access to a premise comprising a plurality of electronic locks each associated with a physical barrier, each electronic lock comprising a lock controller, a lock processor, and a memory storing executable instructions within the electronic lock, comprising:
a lock control device comprising an input unit, a communication unit in wireless communication with the plurality of electronic locks, a processor in electrical communication with the communication unit and the input unit;
a server configured to communicate wirelessly with the lock control device and each electronic lock via a communication network;
wherein the lock control device is configured to:
assign a sequential unlock mode to two or more electronic locks among the plurality of electronic locks;
configure an unlock trigger on a lead electronic lock configured for sequentially unlocking the remaining two or more electronic locks;
receive an unlock event by the lead electronic lock, wherein the unlock event is configured for unlocking the lead electronic lock;
determine if the unlock event matches the unlock trigger on the lead electronic lock for sequentially unlocking the remaining two or more electronic locks;
transmit an unlock command to the remaining electronic locks if the unlock event matches the unlock trigger to activate the sequential unlock mode thereby unlocking the remaining two or more electronic locks in a sequential manner.

16. An access management system for controlling sequential access to a premise comprising a plurality of electronic locks each associated with a physical barrier, each electronic lock comprising a lock controller, a lock processor, and a memory storing executable instructions within the electronic lock, comprising:
a lock control device comprising an input unit, a communication unit in wireless communication with the plurality of electronic locks, a processor in electrical communication with the communication unit and the input unit;
a gateway device arranged in wireless communication with the plurality of electronic locks;
a server configured to communicate wirelessly with the lock control device and the gateway device via a communication network;
wherein the lock control device is configured to:
assign a sequential unlock mode to two or more electronic locks among the plurality of electronic locks;
configure an unlock trigger on a lead electronic lock configured for sequentially unlocking the remaining two or more electronic locks;
receive an unlock event by the lead electronic lock, wherein the unlock event is configured for unlocking the lead electronic lock;
determine if the unlock event matches the unlock trigger on the lead electronic lock for sequentially unlocking the remaining two or more electronic locks;
transmit an unlock command to the remaining electronic locks if the unlock event matches the unlock trigger to activate the sequential unlock mode thereby unlocking the remaining two or more electronic locks in a sequential manner.

17. A method for controlling sequential access to a first electronic lock and a second electronic lock that are not connected to the network, each electronic lock comprising a lock controller, a processor, and a memory storing executable instructions within the electronic lock, the method comprising:
establishing a secure wireless connection between the first electronic lock and the second electronic lock to define a group pair;
generating an access credential for each electronic lock to unlock itself;
transmitting the access credential for each electronic lock to the other electronic lock;
configuring an unlock trigger on one electronic lock for unlocking the other electronic lock in the group pair;
generate an unlock event by the one electronic lock, wherein the unlock event is configured for unlocking the one electronic lock;
determining if the unlock event matches the unlock trigger for unlocking the other electronic lock in the group pair; and
transmitting, by the one electronic lock, an unlock command to the other electronic lock within the group pair if the unlock event matches the unlock trigger.
